(19) United States
(12) Patent Application Publication
(10) Pub. No.: US 2010/0114698 A1
(43) Pub. Date: May 6, 2010

(54) ADVERTISING META-KEYWORDS

(76) Inventors: Kavi J. Goel, Mountain View, CA (US); Mark K. Rose, Los Altos, CA (US); Leora Ruth Wiseman, Zichron Yaakov (IL); Joseph M. Ashear, Palo Alto, CA (US); Frederick R. Vallaeys, Palo Alto, CA (US); Dennis Troper, Los Altos, CA (US); Shawn C. Salmon, Redwood City, CA (US)

Correspondence Address: FISH & RICHARDSON P.C., PO BOX 1022, MINNEAPOLIS, MN, 55440-1022, US

(21) Appl. No.: 12/609,612

(22) Filed: Oct. 30, 2009

Related U.S. Application Data
(60) Provisional application No. 61/110,203, filed on Oct. 31, 2008.

(51) Int. Cl. G06Q 30/00

(52) U.S. Cl. 705/14.49

(57) ABSTRACT

Methods, systems, and apparatus, including computer program products, for generating advertisements from advertising templates. In one implementation, a method includes receiving a meta-keyword and a list of one or more keywords that are associated with the meta-keyword. An advertisement template that includes the meta-keyword is received. An advertisement is generated from the advertisement template. The generated advertisement includes one of the keywords in the list of keywords associated with the meta-keyword.

### CROSS-REFERENCE TO RELATED APPLICATIONS

This application claims the benefit under 35 U.S.C. §119(e) of U.S. Patent Application No. 61/110,203, titled “Advertising Meta-Keywords,” filed Oct. 31, 2008, which is incorporated here by reference.]

### TECHNICAL FIELD

The subject matter of this specification relates to advertising.

### BACKGROUND

Online advertisers use keywords to target their advertisements. An advertiser can associate an advertisement with one or more keywords. When any of the associated keywords appear in a search query or in a webpage, for example, the advertisement may be presented. An advertiser can associate an advertisement with multiple words that are variants of each other or have similar meanings. For example, an advertisement for posters can be associated with multiple words like “photo,” “photos,” “poster,” “posters,” “print,” and “prints,” etc. If the advertiser wishes to mention individual celebrities in the advertisements for posters, the advertiser can create an advertisement for each celebrity the advertiser wishes to mention, where each created advertisement is associated with the multiple words.

### SUMMARY

This specification describes technologies relating to generating advertisements from advertising templates. An advertising template includes one or more meta-keywords, and each meta-keyword is associated with a list of keywords. An advertisement is generated by using one of the keywords in the list of keywords for one of the meta-keywords in place of the meta-keyword in the advertising template.

In general, one aspect of the subject matter described in this specification can be embodied in a method that include the actions of receiving a first meta-keyword and a first list of one or more keywords, the first list associated with the first meta-keyword; receiving a first advertisement template, the first advertisement template including the first meta-keyword; and generating, for at least one keyword in the first list, an advertisement based on the first advertisement template, the generated advertisement including the respective keyword in the first list. Other embodiments of this aspect include corresponding systems, apparatus, and computer programs recorded on computer-readable mediums, each configured to perform the operations of the method.

These and other embodiments can each optionally include one or more of the following features. The method can further include removing a keyword from the first list, and in response to the removing of the keyword from the first list, removing a respective generated advertisement that includes the removed keyword. Receiving the first list of keywords can include receiving the first list from a content feed. The method can further include receiving a search query, the search query including a keyword in the first list, and presenting a generated advertisement that includes the keyword included in the search query.

The method can further include receiving a bid associated with the first meta-keyword, and associating the bid with each of the generated advertisements. The method can further include receiving a bid associated with a keyword in the first list, and associating the bid with a generated advertisement that includes the keyword associated with the bid.

The method can further include receiving a second meta-keyword and a second list of one or more keywords, the second list associated with the second meta-keyword. The method can further include receiving a third meta-keyword and a third list of one or more keywords, the third list associated with the third meta-keyword. The method can further include receiving a second advertisement template, the second advertisement template including the second meta-keyword and the third meta-keyword, and generating, for each combination of a keyword in the second list and a keyword in the third list, an advertisement based on second advertisement template, the generated advertisement including the keyword in the second list and the keyword in the third list. The method can further include receiving a bid associated with a combination of the second meta-keyword and the third meta-keyword, and associating the bid with each of the generated advertisements that include a keyword in the second list and a keyword in the third list. The method can further include receiving a bid associated with a combination of a keyword in the second list and the third meta-keyword, and associating the bid with each of the generated advertisements that include the keyword in the second list and a keyword in the third list.

In general, another aspect of the subject matter described in this specification can be embodied in a method that includes the actions of receiving, in a computer system, a first meta-keyword and a first list of one or more keywords, the first list associated with the first meta-keyword; receiving, in the computer system, an association of the first meta-keyword with an advertisement; receiving, in the computer system, a first search query that includes a first term, wherein the first term matches a keyword in the first list; and presenting, in the computer system, the advertisement in response to the first search query. Other embodiments of this aspect include corresponding systems, apparatus, and computer programs recorded on computer-readable mediums, each configured to perform the operations of the method.

These and other embodiments can each optionally include the following feature. The method can further include receiving a second meta-keyword and a second list of one or more keywords, the second list associated with the second meta-keyword; receiving an association of a combination of the first meta-keyword and the second meta-keyword with the advertisement; receiving a second search query that includes a second term and a third term, wherein the second term matches a keyword in the second list and the third term matches a keyword in the third list; and presenting the advertisement in response to the second search query.

Particular embodiments of the subject matter described in this specification can be implemented to realize one or more of the following advantages. An advertiser can create reusable lists of keywords for use in advertisement targeting. The lists can be static or dynamic. Advertisements for each keyword in the list can be managed together. Multiple keyword lists can be crossed with each other to create keyword combinations for advertisement targeting. Keyword lists can be shared. Access to keyword lists can be sold or traded in a marketplace.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram illustrating an example network environment.

FIG. 2 is a block diagram illustrating an example advertisement distribution system.

FIG. 3 is a flow diagram illustrating an example process for generating advertisements.

FIG. 4 is a flow diagram illustrating an example process for presenting advertisements.

FIGS. 5A-5H illustrate example user interfaces for creating and managing meta-keywords.

FIG. 6 is a block diagram illustrating an example generic computer system.

Like reference numbers and designations in the various drawings indicate like elements.

### DETAILED DESCRIPTION

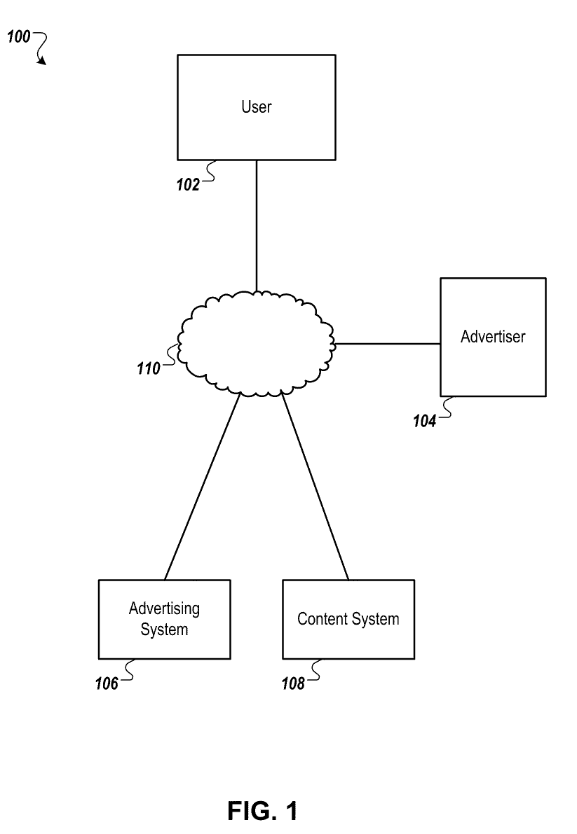

FIG. 1 illustrates an example network environment 100. The network environment 100 includes a user 102, an advertiser 104, an advertising system 106, and a content system 108. These entities in the network environment 100 can communicate over one or more networks 110. The one or more networks 110 can include local area networks, wide area networks, wireless networks, peer-to-peer networks, the Internet, and other networks.

The advertiser 104 advertises to users 102 through advertisements. The advertiser 104 provides advertisements to the advertising system 106. The advertiser 104 creates the advertisements for an advertising campaign and submits them to the advertising system 106. The advertiser 104 can also access the advertising system 106 to manage the campaign, including targeting the advertisements to keywords, selecting a payment scheme (e.g., cost-per-click, cost-per-impression, etc.), and bidding for advertisement placements, for example.

An advertising system 106 distributes advertisements. The advertising system 106 receives advertisements created by the advertiser 104. In some implementations, the advertising system 106 also includes a user interface where an advertiser 104 can create an advertisement. An advertiser 104 who submitted advertisements to the advertising system 106 can also manage, through the advertising system 106, advertising campaigns related the submitted advertisements.

A content system 108 provides users 102 with access to content. The content system 108 receives requests for content from users 102. The content system 108 identifies the content matching the requests, and serves the content to the users 102 or directs users 102 to the content. In some implementations, the content system 108 is a search engine that indexes content from other content systems. The search engine receives search queries. The search engine identifies content that matches the search queries and sends search results corresponding to the matching content to the user. The search results can include hyperlinks to the matching content. In some other implementations, the content system 108 is a content host who hosts the content. The content host can serve the content directly to the users 102. Examples of content that can be provided by the content system 108 include webpages, images, video clips, audio clips, text documents, etc.

The users 102 can access content. A user 102 can direct requests for content to a content system 108. For example, in implementations where the content system 108 is a search engine, a user 102 can submit a search query, which includes one or more terms (e.g., words, phrases, characters, etc.) to the search engine. The search engine returns to the user search results that include hyperlinks to content that satisfies the search query. As another example, in implementations where the content system 108 hosts content, a user can submit to the content system 108 a path of the location (e.g., in a Universal Resource Locator URL)) of the desired content within the content system 108. The content system 108 retrieves the content from the submitted path and serves the content to the user.

The user 102 can be presented advertisements from the advertiser 104. The advertisements can be sent by the advertising system 106 and accompany content sent to the user by the content system 108. In some implementations, the content of the advertisements sent by the advertising system 106 are related to the search query submitted by the user or the content requested by the user.

The user 102 can submit content requests and receive content through a device. Examples of devices include desktop computers, notebook computers, tablet computers, personal digital assistants (PDA's), mobile phones, smart phones, media players, and other types of devices.

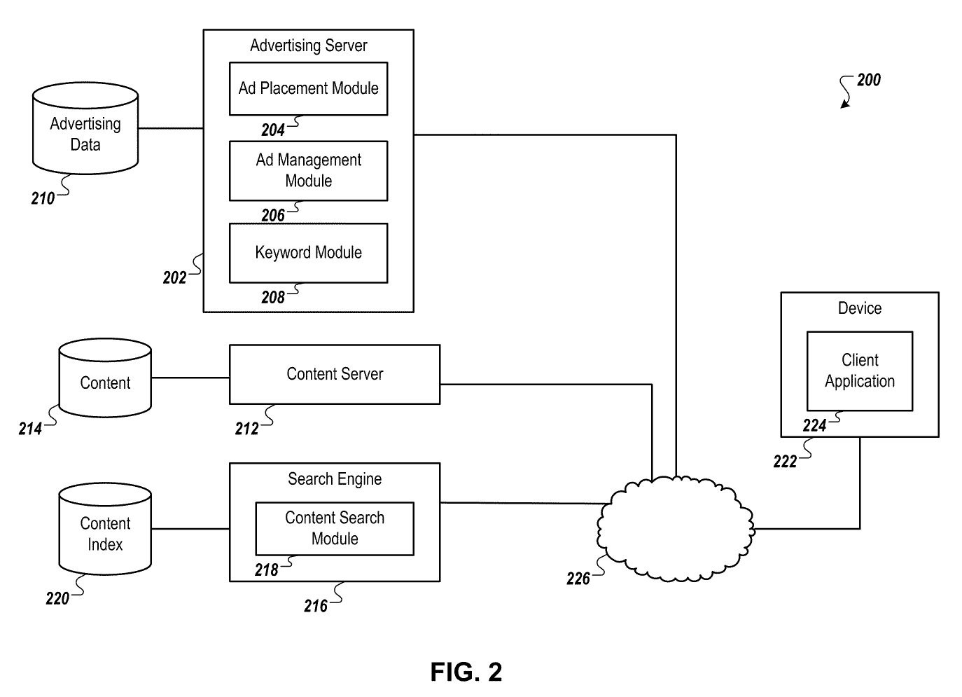

FIG. 2 illustrates an example advertisement distribution system 200. The advertising system 200 includes an advertising server 202, a content server 212, a search engine 216, and a device 222. These components can be connected by one or more networks 226. The one or more networks 220 can include local area networks, wide area networks, wireless networks, peer-to-peer networks, the Internet, and other networks. In some implementations, the advertising server 202 is a part of an advertising system 106, and the search engine 216 and/or the content server 212 are a part of a content system 108.

In some implementations, the search engine 216 includes a content search module 218 and content index 220. The content search module 218 crawls for content and indexes the crawled content in content index 220. The content search module 218 also receives search queries from device 222, identifies from the content index 220 content that satisfies the query, and sends corresponding search results to the device 222.

The content server 212 includes content 214. The content server 212 receives a request for content from the device 222. The content server 212 transmits content 214 that matches the request to the device 222.

The advertising server 202 includes an ad placement module 204, an ad management module 206, a keyword module 208, and advertising data 210. The ad placement module 204 places advertisements with content 214 provided by the content provider 212 and/or search results provided by the search engine 216. The ad management module 206 manages advertising campaigns, including managing auctions for advertisement placements, tracking advertisement performance, and so forth. The advertising data 210 stores data related to advertising, including advertisements, advertising campaign settings, bid values for advertisement placements, etc.

The advertising server 202 also includes a keyword module 208. The keyword module 208 manages keywords that can be associated with advertisements. For example, a keyword can be associated with one or more advertisements, so that whenever the keyword is included in a search query submitted by a user the advertisement is transmitted to a device 222 for presentation to the user.

The keyword module 208 can also manage meta-keywords and associated keyword lists. A meta-keyword is a term (e.g., a word) that represents a list of one or more keywords. The meta-keyword can be, like a keyword, associated with one or more advertisements. In some implementations, associating the meta-keyword with an advertisement automatically associates the keywords in the associated keyword list with the advertisement; whenever a keyword in the list is included in a search query, the advertisement is shown. Additionally, advertisements, each of which include one of the keywords in the keyword list, can be generated based on an advertisement template that includes the meta-keyword. Further details regarding meta-keywords and keyword lists are described below.

A device 222 can be in data communication with the advertising server 202, content server 212, or a search engine 216 through one or more networks 226. In some implementations, the device 222 is configured to interact with the advertising server 202, content server 212, or a search engine 216 through a client application 224, such as a web browser. For example, an advertiser 104 can access a user interface of the advertising server 202 through the client application 224. Within the user interface of the search engine, the advertiser 104 can create and manage advertising campaigns, create and manage advertisements, associate advertisements with keywords, bid for advertisement placements, and so forth. As another example, a user 102 can access a user interface of the search engine 216 through the client application 224. Within the user interface of the search engine, the user 102 can submit queries and view search results, content corresponding to the search results, and advertisements.

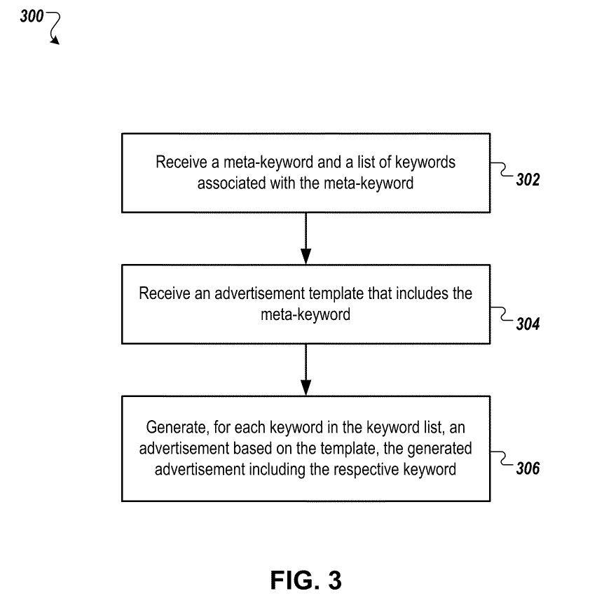

FIG. 3 illustrates a process 300 for generating advertisements using meta-keywords. For convenience, the process 300 will be described in reference to a system (e.g., advertisement distribution system 200), that performs the process 300.

The advertising server 202 receives a meta-keyword and a list of keywords associated with the meta-keyword (302). In some implementations, the advertising server 202 receives a meta-keyword and a list of one or more keywords from an advertiser 104. The meta-keyword represents the list and serves as a name of the list. For example, a keyword list can be named “cities” and include as keywords names of various cities. The name “cities” is the meta-keyword associated with the list.

The advertising server 202 receives an advertisement template from the advertiser (304). The advertisement template defines the content and appearance of an advertisement. Advertisements having the defined content and appearance can be generated from the advertisement template, further details of which are described below.

The advertisement template includes the meta-keyword. For example, a template for a text advertisement, the textual content in the template includes the meta-keyword, which may be set off by predefined symbols to differentiate the meta-keyword from normal text.

The advertising server 202 generates an advertisement for each keyword in the list of keywords (306). In each generated advertisement, the meta-keyword can be replaced by a keyword from the list. Thus, for example, if an advertisement template reads “{Outerwear} at low prices!” with meta-keyword “outerwear,” and the list of keywords are {jackets, pants, hats, boots}, then four advertisements are generated and the four generated advertisements read as follows: “Jackets at low prices!”, “Pants at low prices!”, “Hats at low prices!”, and “Boots at low prices!”. In some implementations, the set of generated advertisements are grouped into one ad group that targets the set of keywords in the list.

In some implementations, the advertisement template can include multiple instances of the same meta-keyword. For example, an advertisement template can read “Great {Outerwear} ! The best {outerwear} at the best prices!”. An advertisement generated from this template can have a keyword from the list replacing each instance of the meta-keyword. For example, an advertisement with the keyword “jackets” can read “Great Jackets! The best jackets at the best prices!”.

In some implementations, an advertisement template can include two or more meta-keywords. An advertisement template can include, for example, one or more instances of a first meta-keyword and one or more instances of a second meta-keyword. For example, an advertisement template can read “The best {outerwear} in {cities}.”, where the meta-keywords are “outerwear” and “cities,” and each of these meta-keywords are associated with respective lists of keywords. An advertisement can be generated using the advertisement template for each pairing of a keyword from the “outerwear” keyword list and a keyword from the “cities” keyword list. For example, if the “outerwear” keywords list include {jackets, pants, hats, boots} and the “cities” keyword list include {New York, San Francisco, Boston, Chicago}, then the generated advertisements can read “The best jackets in Boston,” “The best jackets in Chicago,” “The best pants in Boston,” “The best pants in San Francisco,” and so on. Furthermore, in some implementations, ad groups can be identified based on one of the meta-keywords included in the advertisement template. For example, advertisements can be grouped using the meta-keyword “cities.” That is, advertisements that pairs the keyword “Boston” with each respective one of the keywords in the “outerwear” keyword list are grouped into an ad group, advertisements that pairs the keyword “Chicago” with each respective one of the keywords in the “outerwear” keyword list are grouped into another ad group, and so forth.

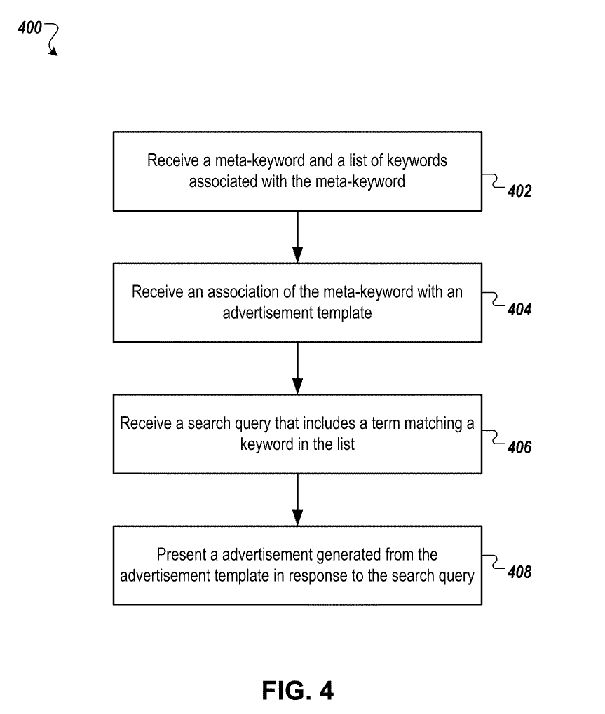

FIG. 4 is a flow diagram illustrating an example process 400 for presenting advertisements. For convenience, the process 400 will be described in reference to a system (e.g., advertisement distribution system 200), that performs the process 400.

Advertising server 202 receives a meta-keyword and a list of keywords associated with the meta-keyword (402). In some implementations, the advertising server 202 receives a meta-keyword and a list of one or more keyword from an advertiser 104. The meta-keyword represents the list and serves as a name of the list. For example, a keyword list can be named “cities” and include as keywords names of various cities. The name “cities” is the meta-keyword associated with the list.

Advertising server 202 receives an association of the meta-keyword with an advertisement template (404). In some implementations, the association is created by the insertion of the meta-keyword into the content of advertisement template. The insertion can be made by the advertiser 104. For example, the advertiser 104 can create an advertisement template that includes the meta-keyword in the text of the advertisement template. Advertisements generated from the advertisement template are also associated with the meta-keyword.

Search engine 216 receives a search query, where the query includes a term that matches a keyword in the keyword list (406). The query can be submitted by a user through a user interface of the search engine, accessed from the client application 224 at the device 222, for example.

The content search module 218 of the search engine 216 identifies content (e.g., web pages, images, etc.) in content index 220 that satisfies the search query. The content search module 218 generates a search results page that can, for example, include hyperlinks to the content that satisfy the query. The content search module 218 can include advertisements associated with or related to the search query. The content search module 218 provides the search query to advertising server 202. The ad placement module 204 identifies advertisement templates having a meta-keyword whose keyword list include the search query term. For example, the ad placement module 204 identifies the advertisements generated from the advertisement template that includes the meta-keyword, whose keyword list includes a term that matches a search query term. The ad placement module 204 provides an advertisement generated from the identified advertisement, with the meta-keyword in the advertisement replaced by the matching keyword from the keyword list, to the content search module 218 for placement in the search results page.

The content search module 218 receives the advertisement from the advertising server 202. The content search module 218 places the advertisement into the search results page and transmits the search results page to the device 222. The search results page, including the advertisement, is presented at the device 222 in response to the search query (408).

In some implementations, an advertisement template can include multiple meta-keywords, each associated with a respective keyword list. An advertisement generated from this advertisement template can be selected for presentation in response to a search query if the query includes matching terms for each of the multiple meta-keywords in the advertisement template.

In some implementations, if the advertisement template includes multiple meta-keywords and the search query does not include matching terms for each of the meta-keywords, advertisements generated from the advertisement template are not selected for presentation in response to the search query.

More generally, the input terms based on which advertisements are generated from the advertisement can come from any suitable source. FIG. 4 describes an implementation where the source of the input terms is a search query. Other examples of sources of input terms include electronic messages (e.g., email, instant messages) that have been processed to identify the relevant terms in the messages, web pages, etc. Thus, for example, the advertising server 202 can receive the relevant terms of an email message, some or all of which match one or more keywords associated with the meta-keyword, and the server 202 can generate an advertisement from the advertisement template based the matching terms.

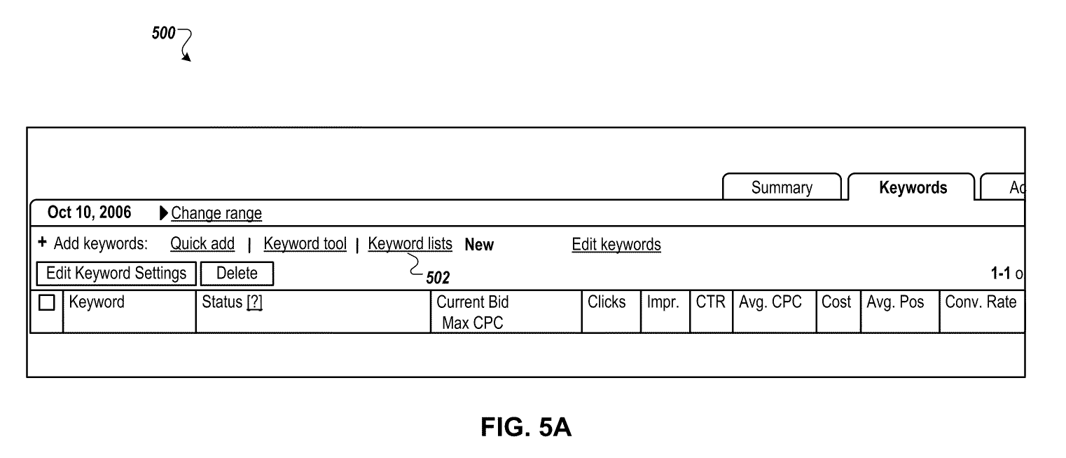

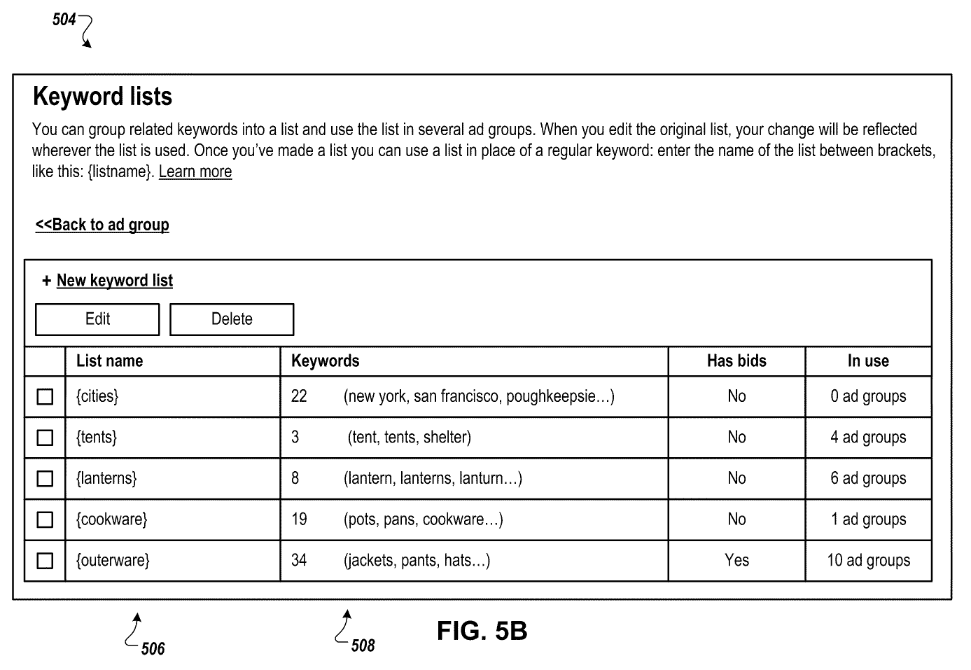

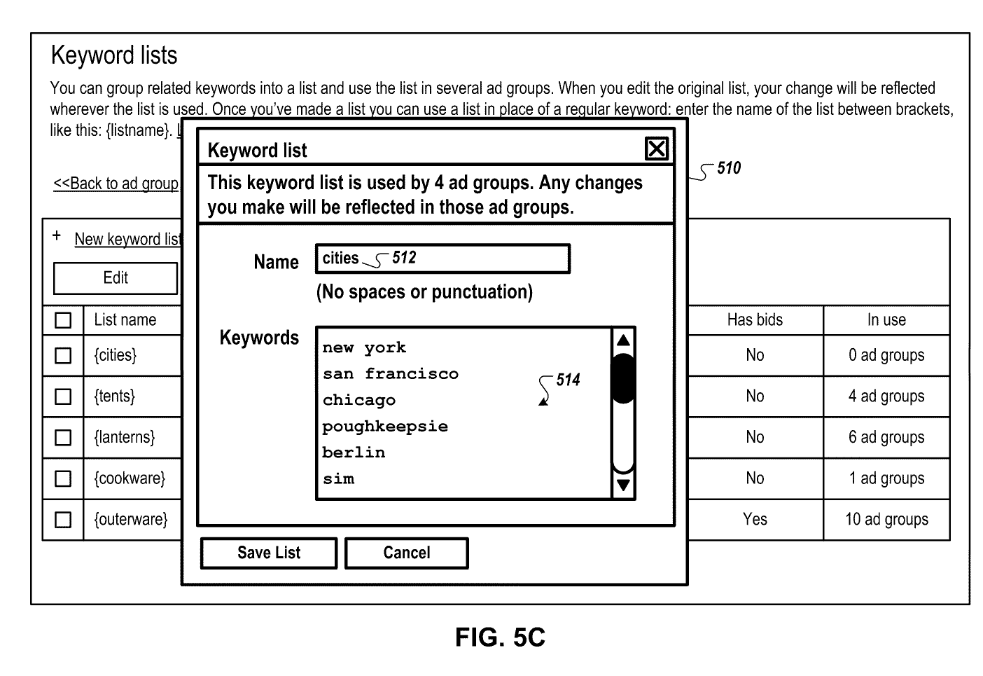

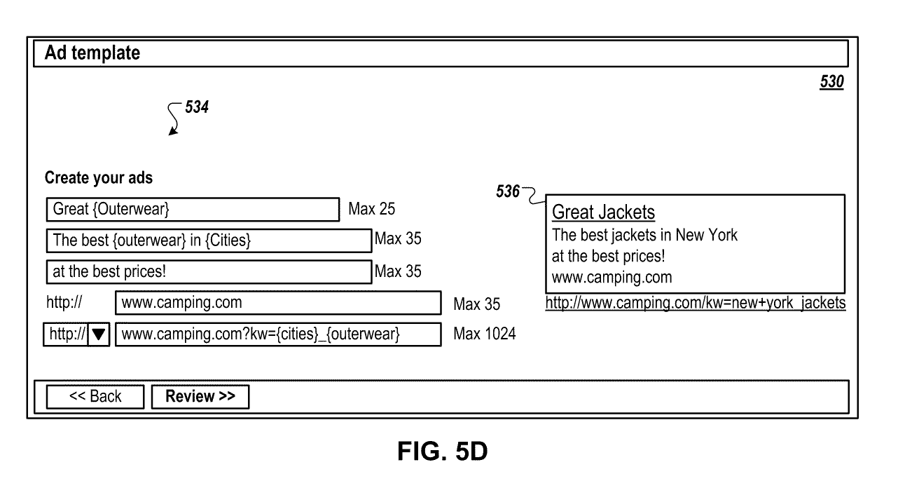

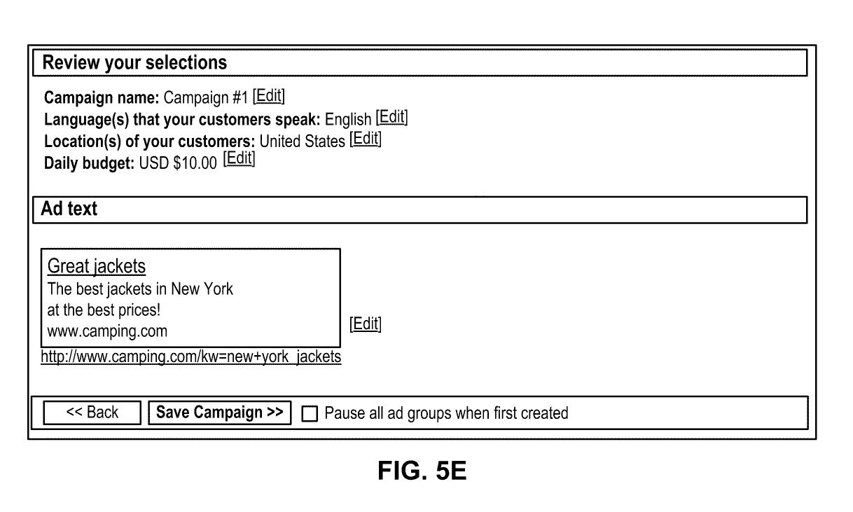

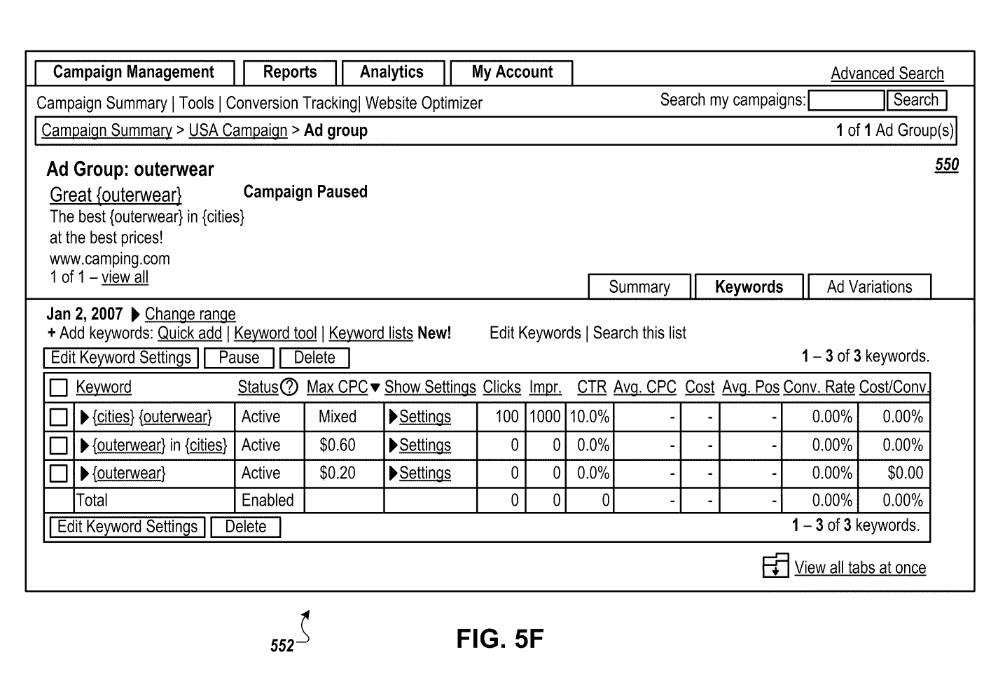

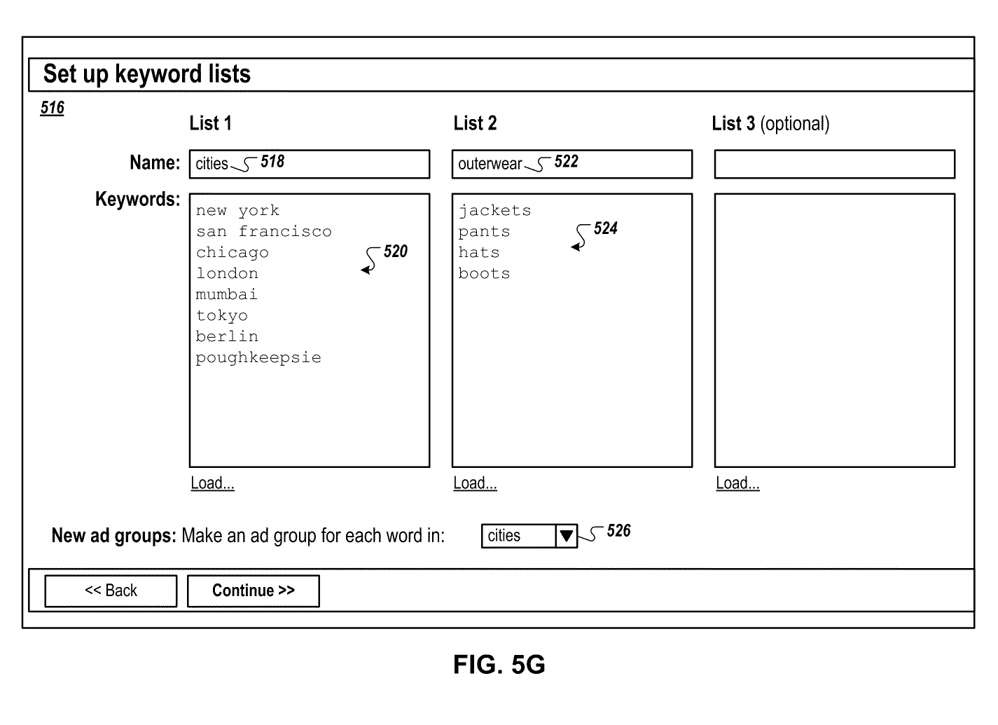

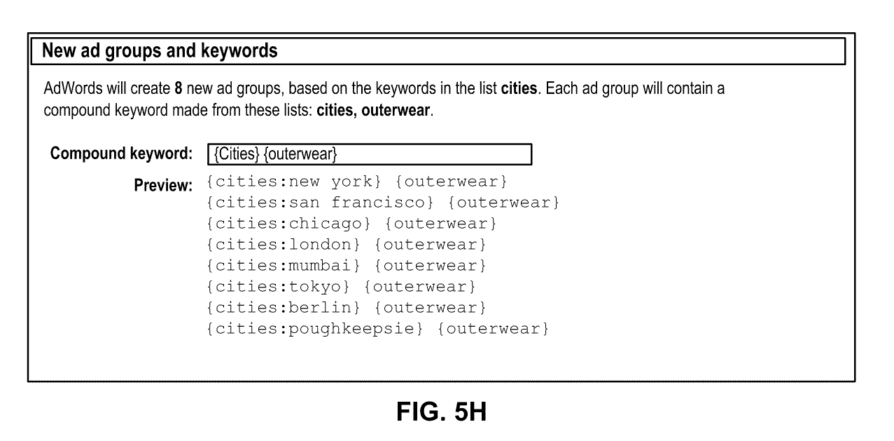

FIGS. 5A-5H illustrate example user interfaces for creating and managing meta-keywords and ad groups that use meta-keywords. In some implementations, the illustrated user interfaces are implemented in webpages served from the advertising server 202.

FIG. 5A illustrates an example user interface page 500 for managing ad campaigns. The page 500 includes a link 502 to a page for managing meta-keywords and keyword lists.

FIG. 5B illustrates an example keyword lists page 504. The keyword lists page 504 shows meta-keywords 506 (which can also serve as the names of keyword lists) and the respective keyword lists 508 associated with the meta-keywords 506.

FIG. 5C illustrates an example user interface 510 for creating or editing a meta-keyword and a corresponding keyword list. The advertiser can enter (or edit) a meta-keyword 512 and the keywords 514 in the keyword list to be associated with the meta-keyword 512. For example, in FIG. 5C, the entered meta-keyword is “cities,” and the keywords in the keyword list for “cities” include “new york,” “san francisco,” “chicago,” etc.

FIG. 5D illustrates an example page 530 for creating or editing an advertisement template (“ad template”). The page 530 includes one or more text fields 534 where the advertiser can create or edit an ad template. An ad template can include one or more lines of text, including one or more lines of Universal Resource Locators (URLs). The ad template can include one or more meta-keywords in the URL and/or the non-URL text. A preview 536 of an advertisement generated according to the template can be presented. The preview 536 shows an example advertisement generated according to the template, with each meta-keyword replaced by a keyword from its respective keyword lists.

As shown in FIG. 5D, the ad template text entered into the text fields 534 includes the meta-keywords {outerwear} and {cities}. The URL also can include meta-keywords. In the advertisement preview 536, instances of the meta-keyword {outerwear} is replaced by “jacket” and instances of the meta-keyword {cities} is replaced by “new york.” Instances of the {outerwear} and {cities} in the URL are also replaced with “jacket” and “new york,” respectively. If the advertiser enters into the template a meta-keyword that does not exist yet in the advertiser's account, the meta-keyword editing interface 510 can be shown to the advertiser, and the advertiser can enter the keywords for the new meta-keyword.

In the example user interface page shown in FIG. 5E, the advertiser can confirm the advertisement template and proceed to creating an advertisement campaign with the advertisement template.

FIG. 5F illustrates an example page 550 for viewing advertisement statistics (e.g., status, bid, clicks, impressions, conversion rate, etc.). In page 550, statistics 552 for advertisements associated with the meta-keyword “outerwear” is shown. The shown statistics include statistics for advertisements generated using the meta-keyword combinations “{cities} {outerwear},” “{outerwear} in {cities},” and “{outerwear},” where {cities} and {outerwear} are meta-keywords. In some implementations, a meta-keyword combination can include multiple ad groups. For example, the “{cities} {outerwear}” combination includes multiple ad groups (e.g., an ad group for each keyword in the keyword list associated with {cities}).

FIG. 5G illustrates another example interface for creating or editing meta-keywords and keyword lists. Page 516 includes one or more fields for entering or editing one or more meta-keywords and for entering or editing keywords for the meta-keywords. The advertiser can enter meta-keywords 518 and 522, for example, and optionally additional meta-keywords. The advertiser can enter and/or edit keyword lists (e.g., lists 520, 524) associated with the meta-keywords.

In some implementations, the advertiser can select a meta-keyword from multiple meta-keywords and one or more ad groups can be generated from the selected meta-keyword. For example, in page 516, the advertiser can select the meta-keyword “cities” or “outerwear,” and ad groups can be generated from each of the keywords associated with the selected meta-keyword. The advertiser can make the selection using a pull-down menu 526, for example. An ad group is generated for each keyword in the keyword list associated with the selected meta-keyword. Each ad group can have its own advertisement template and/or include additional meta-keywords. FIG. 5H shows an example of ad groups generated from keywords associated with a “cities” meta-keyword, each of which also includes a second meta-keyword “outerwear.”

In some implementations, meta-keywords can be nested. For example, a “Cities” meta keyword can include the keywords {New York, Los Angeles, Chicago}. The keyword “New York” can itself be meta-keyword associated with the keywords {New York, N.Y. City, NYC}. As illustrated in this example, nested meta-keywords can be used to indicate, among other things, synonyms or alternate names.

In some implementations, meta-keywords and keyword lists can be created by an entity other than the advertiser 104 and stored at the advertising server 202. An advertiser 104 creating an advertisement template can insert a meta-keyword created by another entity into an advertisement template, effectively subscribing to the meta-keyword and the keyword list created by the another entity. The keyword list can be modified by the another entity as well. For example, a franchiser can create and maintain meta-keywords and associated keyword lists, which franchisees can use for their local advertisements.

In some implementations, a keyword list for a meta-keyword can include a default keyword. In an advertisement generated from an advertisement template with the meta-keyword, the meta-keyword can be replaced with the default keyword if replacing the meta-keyword with another keyword in the keyword list would cause the advertisement text to exceed a length limit, for example.

In some implementations, when the advertisement template includes multiple meta-keywords, the advertiser 104 can set an exclusion parameter or filter to exclude advertisements with particular keyword combinations. For example, if an advertisement template includes the meta-keywords {brand}=(Apple, Toshiba, Dell) and {device}=(laptop, handheld), an exclusion parameter or filter can be set so that advertisements with the particular keyword combination “Toshiba” and “handheld” is not generated.

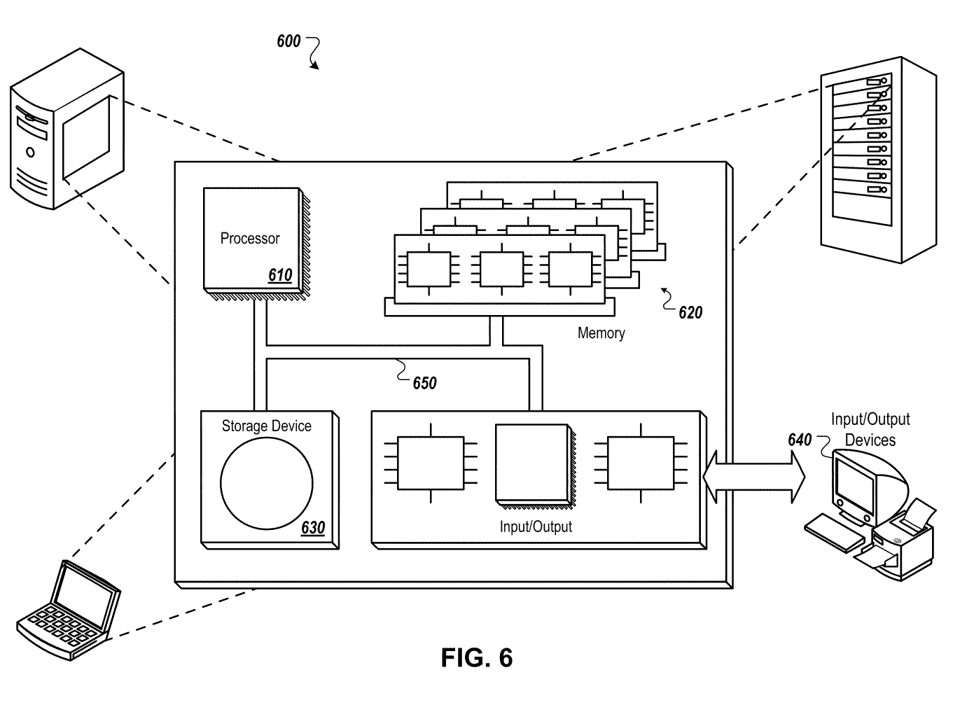

FIG. 6 illustrates a generic computer system 600. The system 600 can be used for practicing operations described above. The system 600 can include a processor 610, memory 620, a storage device 630, and input/output devices 640. Each of the components 610, 620, 630, and 640 are interconnected using a system bus 650. The processor 610 is capable of processing instructions for execution within the system 600. Such executed instructions can implement one or more components of search engine 216, advertising server 202, content server 212, or device 222, for example. In some implementations, the processor 610 is a single-threaded processor. In other implementations, the processor 610 is a multi-threaded processor. The processor 610 is capable of processing instructions stored in the memory 620 or on the storage device 630 to display graphical information for a user interface on the input/output device 640.

The memory 620 is a computer readable medium such as volatile or non-volatile memory that stores information within the system 600. The memory 620 could store data structures representing content index 220, content 214, or advertising data 210, for example. The storage device 630 is capable of providing persistent storage for the system 600. The storage device 630 may be a floppy disk device, a hard disk device, an optical disk device, or a tape device, or other suitable persistent storage means. The input/output device 640 provides input/output operations for the system 600. In some implementations, the input/output device 640 includes a keyboard and/or pointing device. In other implementations, the input/output device 640 includes a display unit for displaying graphical user interfaces.

The disclosed and other embodiments and the functional operations described in this specification can be implemented in digital electronic circuitry, or in computer software, firmware, or hardware, including the structures disclosed in this specification and their structural equivalents, or in combinations of one or more of them. The disclosed and other embodiments can be implemented as one or more computer program products, i.e., one or more modules of computer program instructions encoded on a computer-readable medium for execution by, or to control the operation of, data processing apparatus. The computer-readable medium can be a machine-readable storage device, a machine-readable storage substrate, a memory device, or a combination of one or more them. Alternatively or in addition, the program instructions can be encoded in a propagated signal that is an artificially generated signal, e.g., a machine-generated electrical, optical, or electromagnetic signal, that is generated to encode information for transmission to suitable receiver apparatus for execution by a computer data processing apparatus. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, the disclosed embodiments can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The disclosed embodiments can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of what is disclosed here, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of what being claims or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understand as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments have been described. Other embodiments are within the scope of the following claims.

What is claimed is:

1. A method comprising:
receiving, in a computer system, a first meta-keyword and a first list of one or more keywords, the first list associated with the first meta-keyword;
receiving, in the computer system, a first advertisement template, the first advertisement template including the first meta-keyword; and
generating, with the computer system, for at least one keyword in the first list, an advertisement based on the first advertisement template, the generated advertisement including the respective keyword in the first list.

2. The method of claim 1, further comprising:
removing a keyword from the first list; and
in response to the removing of the keyword from the first list, removing a respective generated advertisement that includes the removed keyword.

3. The method of claim 1, wherein receiving the first list of keywords comprises receiving the first list from a content feed.

4. The method of claim 1, further comprising:
receiving a search query, the search query including a keyword in the first list; and
presenting a generated advertisement that includes the keyword included in the search query.

5. The method of claim 1, further comprising:
receiving a bid associated with the first meta-keyword; and
associating the bid with each of the generated advertisements.

6. The method of claim 1, further comprising:
receiving a bid associated with a keyword in the first list; and
associating the bid with a generated advertisement that includes the keyword associated with the bid.

7. The method of claim 1, further comprising:
receiving a second meta-keyword and a second list of one or more keywords, the second list associated with the second meta-keyword;
receiving a third meta-keyword and a third list of one or more keywords, the third list associated with the third meta-keyword
receiving a second advertisement template, the second advertisement template including the second meta-keyword and the third meta-keyword; and
generating, for each combination of a keyword in the second list and a keyword in the third list, an advertisement based on second advertisement template, the generated advertisement including the keyword in the second list and the keyword in the third list.

8. The method of claim 7, further comprising:
receiving a bid associated with a combination of the second meta-keyword and the third meta-keyword; and
associating the bid with each of the generated advertisements that include a keyword in the second list and a keyword in the third list.

9. The method of claim 7, further comprising:
receiving a bid associated with a combination of a keyword in the second list and the third meta-keyword; and
associating the bid with each of the generated advertisements that include the keyword in the second list and a keyword in the third list.

10. A method, comprising:
receiving, in a computer system, a first meta-keyword and a first list of one or more keywords, the first list associated with the first meta-keyword;
receiving, in the computer system, an association of the first meta-keyword with an advertisement;
receiving, in the computer system, a first search query that includes a first term, wherein the first term matches a keyword in the first list; and
presenting, in the computer system, the advertisement in response to the first search query.

11. The method of claim 10, further comprising:
receiving a second meta-keyword and a second list of one or more keywords, the second list associated with the second meta-keyword;
receiving an association of a combination of the first meta-keyword and the second meta-keyword with the advertisement;
receiving a second search query that includes a second term and a third term, wherein the second term matches a keyword in the second list and the third term matches a keyword in the third list; and
presenting the advertisement in response to the second search query.

12. A system, comprising:
one or more processors; and
a computer-readable medium encoded with a computer program, the computer program comprising instructions configured for executions by the one or more processors, which, when executed by the one or more processors, causes the one or more processors to perform operations comprising:
receive a first meta-keyword and a first list of one or more keywords, the first list associated with the first meta-keyword;
receive a first advertisement template, the first advertisement template including the first meta-keyword; and
generate, for at least one keyword in the first list, an advertisement based on the first advertisement template, the generated advertisement including the respective keyword in the first list.

13. A system, comprising:
one or more processors; and
a computer-readable medium encoded with a computer program, the computer program comprising instructions configured for executions by the one or more processors, which, when executed by the one or more processors, causes the one or more processors to perform operations comprising:
receive a first meta-keyword and a first list of one or more keywords, the first list associated with the first meta-keyword;
receive an association of the first meta-keyword with an advertisement;
receive a first search query that includes a first keyword, wherein the first term matches a keyword in the first list; and
present the advertisement in response to the first search query.

14. A computer-readable medium encoded with a computer program, the computer program comprising instructions operable to cause data processing apparatus to perform operations comprising:
receiving a first meta-keyword and a first list of one or more keywords, the first list associated with the first meta-keyword;
receiving a first advertisement template, the first advertisement template including the first meta-keyword; and
generating, for at least one keyword in the first list, an advertisement based on the first advertisement template, the generated advertisement including the respective keyword in the first list.

15. A computer-readable medium encoded with a computer program, the computer program comprising instructions operable to cause a data processing apparatus to perform operations comprising:
receiving a first meta-keyword and a first list of one or more keywords, the first list associated with the first meta-keyword;
receiving an association of the first meta-keyword with an advertisement;
receiving a first search query that includes a first keyword, wherein the first term matches a keyword in the first list; and
presenting the advertisement in response to the first search query.

16. A system, comprising:
means for receiving a first meta-keyword and a first list of one or more keywords, the first list associated with the first meta-keyword;
means for receiving a first advertisement template, the first advertisement template including the first meta-keyword; and
means for generating, for at least one keyword in the first list, an advertisement based on the first advertisement template, the generated advertisement including the respective keyword in the first list.

17. A system, comprising:
means for receiving a first meta-keyword and a first list of one or more keywords, the first list associated with the first meta-keyword;
means for receiving an association of the first meta-keyword with an advertisement;
means for receiving a first search query that includes a first keyword, wherein the first term matches a keyword in the first list; and
means for presenting the advertisement in response to the first search query.
